(19) United States
(12) Patent Application Publication
(10) Pub. No.: US 2025/0331636 A1
(43) Pub. Date: Oct. 30, 2025

(54) ADJUSTABLE FIXTURE SUPPORT MAGNET, AND RELATED SYSTEM AND METHOD

(71) Applicant: Kluods Construction Inc., Scarborough (CA)

(72) Inventor: Ultan O'Donnell, Scarborough (CA)

(73) Assignee: Kluods Construction Inc., Scarborough (CA)

(21) Appl. No.: 19/183,438

(22) Filed: Apr. 18, 2025

Related U.S. Application Data
(60) Provisional application No. 63/636,466, filed on Apr. 19, 2024.

(51) Int. Cl. A47B 95/00; F16M 13/02; H01F 7/02

(52) U.S. Cl. CPC A47B 95/008; F16M 13/022; H01F 7/0252

(57) ABSTRACT

The present specification relates generally to devices, methods and systems for installing fixtures, and more specifically to an adjustable fixture support magnet and a related method and system. The adjustable fixture support magnet comprises a magnet; a receptacle configured to receive the magnet; a cover, comprising an external first screw thread; a locking mechanism removably connecting the receptacle with the cover; and a base, comprising an internal second screw thread corresponding to the first screw thread. The system for magnetically mounting at least one fixture comprises at least one fixture support magnet; at least one support bracket; and at least one magnetic plate. A method of magnetically mounting at least one fixture is also provided.

### FIELD OF THE INVENTION

The present specification relates generally to devices, methods and systems for installing fixtures, and more specifically to an adjustable fixture support magnet and a related method and system.

### BACKGROUND OF THE INVENTION

As businesses, workplaces, families and lifestyles evolve, so too must offices, homes, apartments and other spaces. Often times, the changes which need to be made to spaces are not extensive. Repositioning shelving as children grow and replacing cabinets that have suffered wear over time are just two examples. Despite the limited scope of these changes, the work involved can be significant due to these being fixtures which are mounted to walls. Removing, and repositioning these fixtures results in damage to paint and drywall which needs to be covered up or corrected. These small jobs can also create waste in the form of crumbled drywall, insulation, paint chips, and other materials. Many homeowners and business owners also lack the knowledge and experience required to complete these tasks independently and are forced to hire contractors to complete the work, making the task expensive.

To avoid the cost, waste and labour involved with repositioning fixtures in the future, businessowners, homeowners and similar have resorted to methods of temporary installation of fixtures which permit repositioning and removal without damage to the supporting wall. One example is the use of adhesive strips to support lighter fixtures. These strips, however, are limited in the amount of weight they can support. Alone or in combination adhesive strips can often support as much as 8 lbs, but not much more. Further, adhesive strips can lose their adhesive strength over time and may be susceptible to changes in temperature or humidity. Adhesive strips may also damage surfaces to which they are applied.

Accordingly, there remains a need for improvements in the art.

### SUMMARY OF THE INVENTION

In an embodiment of the present invention, there is provided an adjustable fixture support magnet, comprising: a magnet; a receptacle configured to receive the magnet; a cover, comprising an external first screw thread; a locking mechanism removably connecting the receptacle with the cover; and a base, comprising an internal second screw thread corresponding to the first screw thread.

According to another embodiment, there is provided a system for magnetically mounting at least one fixture, comprising: at least one fixture support magnet as described herein; at least one support bracket; and at least one magnetic plate.

According to yet another embodiment, there is provided a method of magnetically mounting at least one fixture, comprising: installing at least one magnetic plate behind at least one section of drywall; affixing at least one fixture support magnet to a rear face of the at least one fixture; positioning the rear face of the at least one fixture parallel to and proximate the at least one magnetic plate.

Other aspects and features according to the present application will become apparent to those ordinarily skilled in the art upon review of the following description of embodiments of the invention in conjunction with the accompanying figures.

### BRIEF DESCRIPTION OF THE DRAWINGS

The principles of the invention may better be understood with reference to the accompanying figures provided by way of illustration of an exemplary embodiment, or embodiments, incorporating principles and aspects of the present invention, and in which:

FIG. 1 is a top perspective view of an adjustable fixture support magnet, according to an embodiment, magnet not shown;

FIG. 2 is a top perspective view of a base of the adjustable fixture support magnet of FIG. 1;

FIG. 3 is a top perspective view of a cover of the adjustable fixture support magnet of FIG. 1;

FIG. 4 is a close-up view of a component of a locking mechanism of the adjustable fixture support magnet of FIG. 1;

FIG. 5 is a bottom perspective view of a receptacle of the adjustable fixture support magnet of FIG. 1;

FIG. 6 is a bottom perspective view of the adjustable fixture support magnet of FIG. 1, in an unlocked configuration, base and magnet not shown;

FIG. 7 is a front plan view of the adjustable fixture support magnet of FIG. 1, in an unlocked configuration;

FIG. 8 is a top perspective view of the adjustable fixture support magnet of FIG. 1, in a disassembled configuration, magnet not shown;

FIG. 9 is a close-up view of a component of a locking mechanism of the adjustable fixture support magnet of FIG. 1;

FIG. 10 is a close-up view of a screw hole in a base of the adjustable fixture support magnet of FIG. 1;

FIG. 11 is a schematic of a support bracket, according to an embodiment;

FIG. 12 is a photograph of a support bracket and magnetic plate installed in a wall, according to an embodiment; and

FIG. 13 is a photograph of a support bracket and magnetic plate installed in a wall, and a hole in a corresponding section of drywall patched, according to an embodiment.

### DETAILED DESCRIPTION OF THE EMBODIMENTS

The description that follows, and the embodiments described therein, are provided by way of illustration of an example, or examples, of particular embodiments of the principles of the present invention. These examples are provided for the purposes of explanation, and not of limitation, of those principles and of the invention. In the description, like parts are marked throughout the specification and the drawings with the same respective reference numerals. The drawings are not necessarily to scale and, in some instances, proportions may have been exaggerated in order more clearly to depict certain features of the invention.

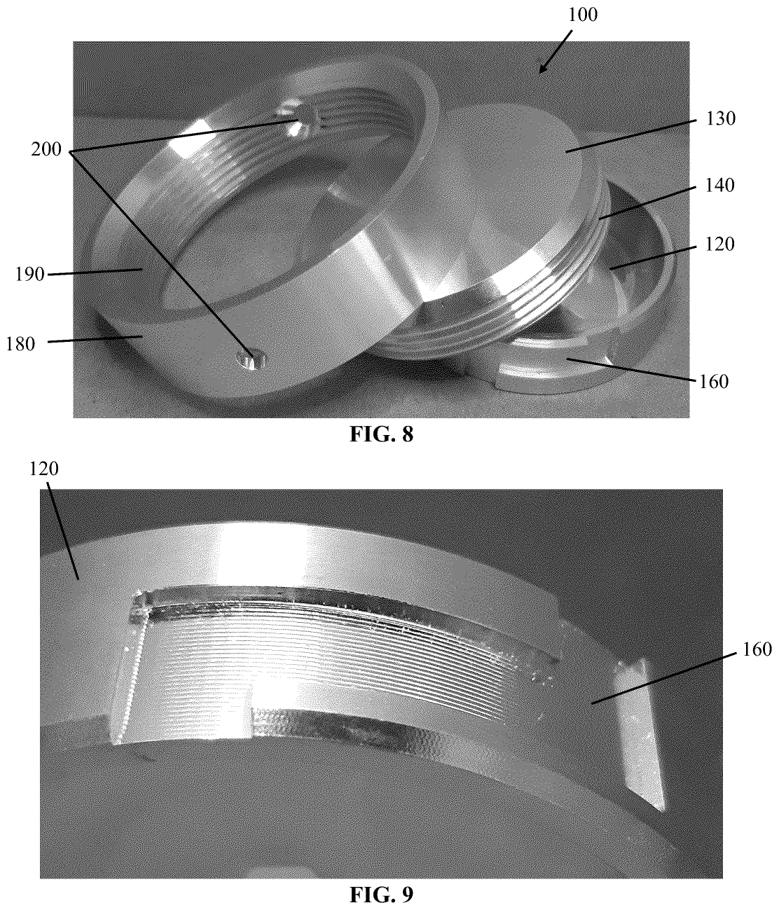

According to an embodiment, as shown in FIGS. 1, 7 and 8, an adjustable fixture support magnet 100 is provided to enable the temporary installation of a variety of fixtures, and particularly heavy floating fixtures and/or weight-bearing fixtures. Accordingly, adjustable fixture support magnet 100 may reduce an amount of waste created in the course of repositioning fixtures after installation, and an amount of money, time, energy and experience required to reposition fixtures after installation. Adjustable fixture support magnet 100 may thereby make adjustment and/or repositioning and/or removal of fixtures more accessible after installation. Further, adjustable fixture support magnet 100 may reduce damage to finished surfaces which would otherwise result from adjustment and/or repositioning and/or removal of fixtures affixed to these surfaces.

Adjustable fixture support magnet 100 comprises a magnet 110. Magnet 110 may vary in size and shape. According to an embodiment, magnet 100 is circular. Magnet 110 may also vary in magnetic strength. Magnet 110 may have a magnetic strength of 100 lbs. A magnetic strength of magnet 110 may be selected based on an intended use of adjustable fixture support magnet 100. For example, a magnetic strength of magnet 110 may be greater where a fixture to be supported by adjustable fixture support magnet 100 is itself particularly heavy or will be loaded with substantial weight in the nature of items placed on shelves or within cabinets. According to an embodiment, magnet 110 is 0.5 inches deep and has a diameter of 2 inches. Magnet 110 may be one of a neodymium, samarium cobalt, alnico or ceramic/ferrite magnet. According to an embodiment, magnet 110 is a neodynium magnet.

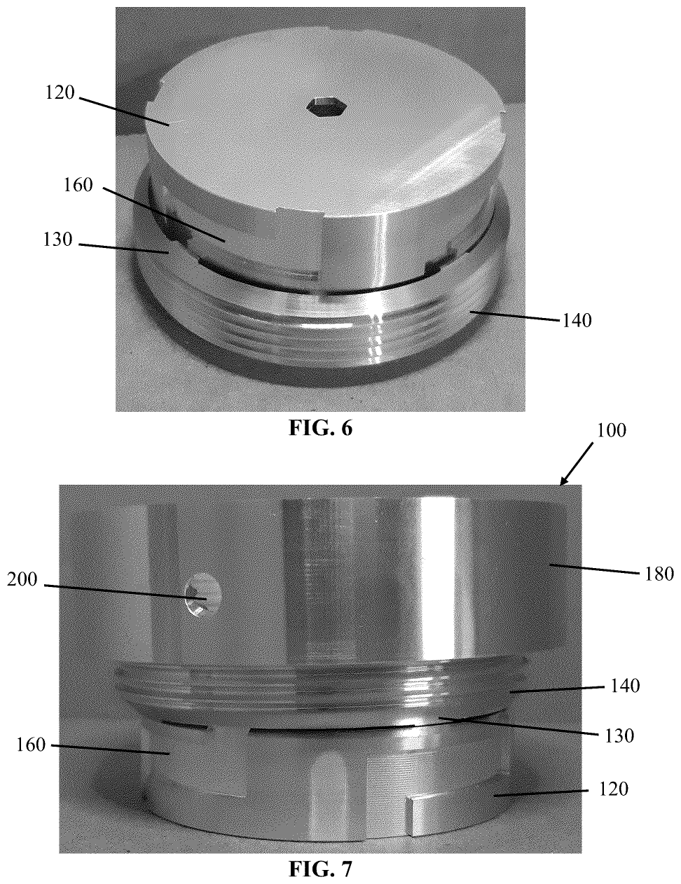

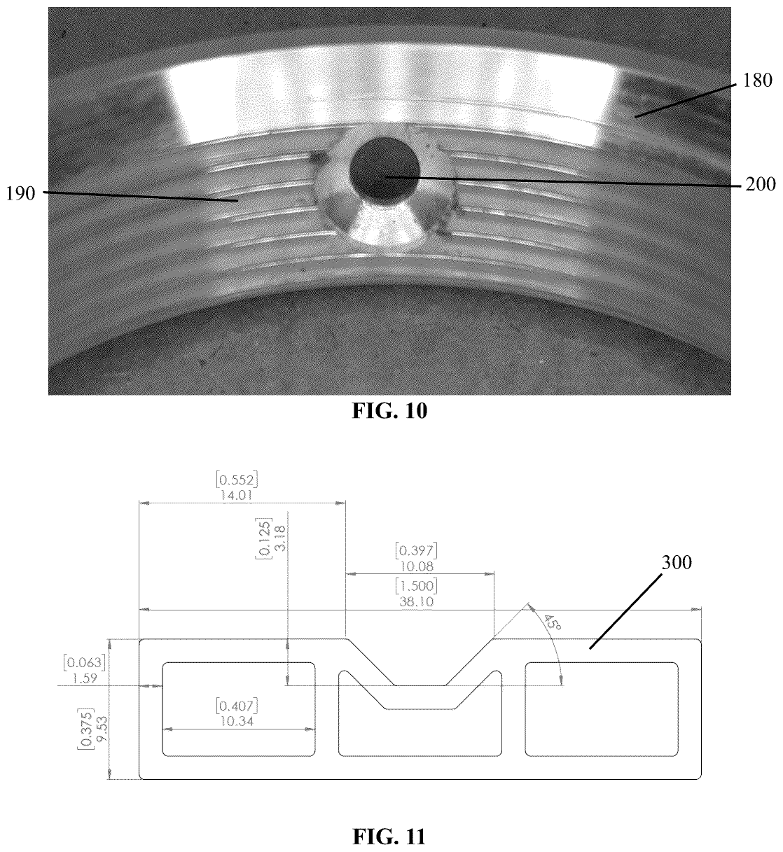

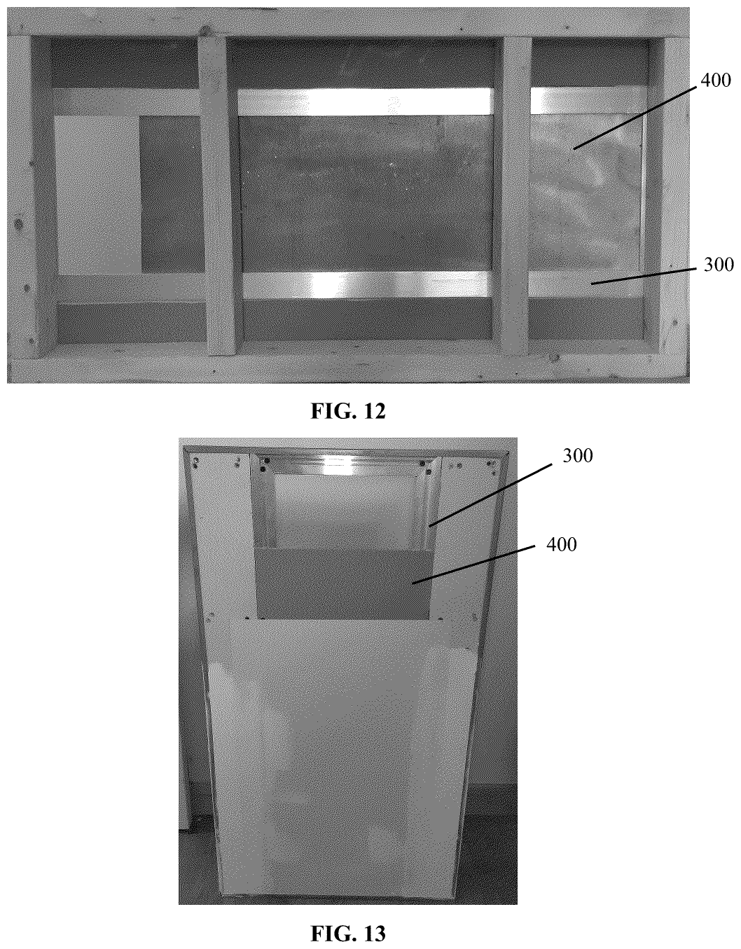

As shown in FIGS. 1 and 5-9, adjustable fixture support magnet 100 comprises a receptacle 120 configured to receive magnet 110. Receptacle 120 may be constructed of one or a combination of aluminum, steel, and thermoplastic. According to an embodiment, receptacle 120 is constructed of aluminum. Receptacle 120 may vary in size and shape. According to an embodiment, receptacle 120 is substantially circular. According to an embodiment, receptacle 120 comprises a recess in a shape corresponding to a shape of magnet 110.

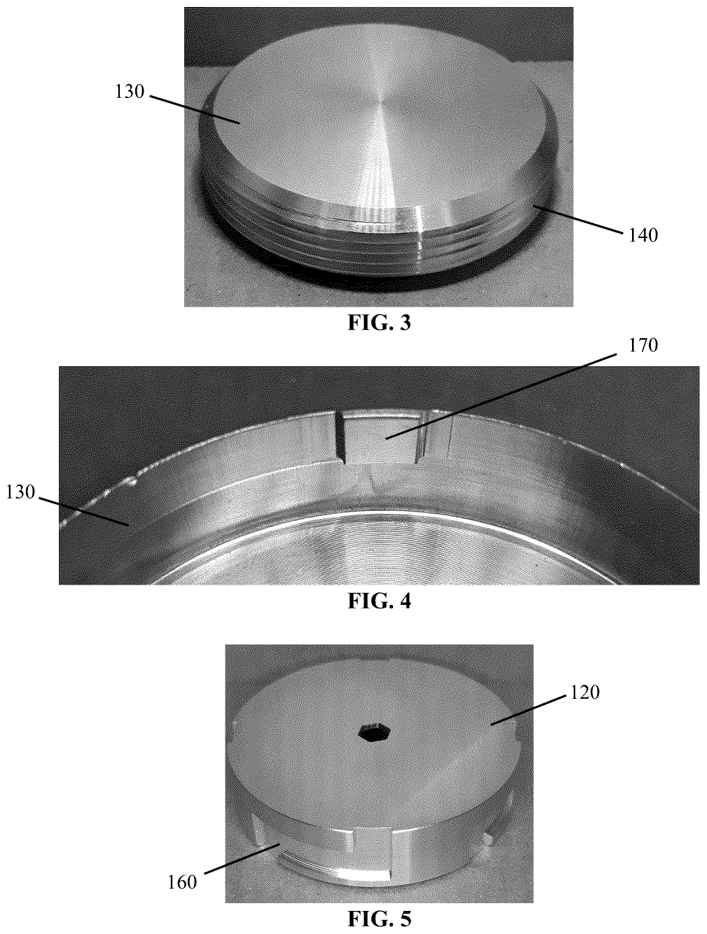

As shown in FIGS. 1, 3, 4 and 6-8, adjustable fixture support magnet 100 further comprises a cover 130, comprising an external first screw thread 140. Cover 130 may be constructed of one or a combination of aluminum, steel, and thermoplastic. According to an embodiment, cover 130 is constructed of aluminum. Cover 130 may vary in size and shape. According to an embodiment, cover 130 is substantially circular. Cover 130 may have a shape of an open-bottom cylinder. First screw thread 140 may vary in thread pitch and thread fit. According to an embodiment, first screw thread 140 has one of a 1A thread fit and a 1B thread fit. According to an embodiment, first screw thread 140 has a thread pitch of 0.08333 inches.

As shown in FIGS. 4-9, adjustable fixture support magnet 100 further comprises a locking mechanism removably connecting receptacle 120 with cover 130. The locking mechanism may comprise a first locking component 160 on receptacle 120 and a corresponding second locking component 170 on cover 130. According to an embodiment, first locking component 160 is a recessed track in an outer surface of receptacle 120 and second locking component 170 is a projection on an inner surface of cover 130 of a size corresponding to a width of the recessed track, as shown in FIGS. 4-9. A position and makeup of the locking mechanism may vary.

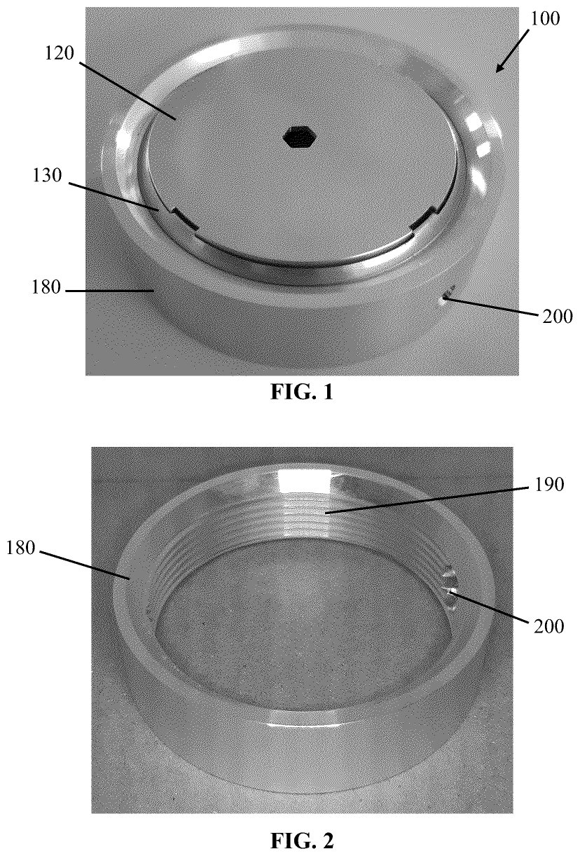

As shown in FIGS. 1, 2, 7, 8 and 10, adjustable fixture support magnet 100 further comprises a base 180, comprising an internal second screw thread 190 corresponding to first screw thread 140. Base 180 may be constructed of one or a combination of aluminum, steel, and thermoplastic. According to an embodiment, base 180 is constructed of aluminum. Base 180 may vary in size and shape. According to an embodiment, base 180 is substantially circular. Base 180 may comprise at least one screw hole 200, as shown in FIG. 10. According to an embodiment, at least one screw hole 200 is disposed within a side face of base 180. Second screw thread 190 may vary in thread pitch and thread fit. According to an embodiment, second screw thread 190 has one of a 1A thread fit and a 1B thread fit. According to an embodiment, second screw thread 190 has a thread pitch of 0.08333 inches. According to a further embodiment, second screw thread 190 has a 1B thread fit and first screw thread 140 has a 1A thread fit. Alternatively, second screw thread 190 may have a 1A thread fit and first screw thread 140 may have a 1B thread fit.

Adjustable fixture support magnet 100 may be constructed from materials which provide sufficient mechanical strength and durability to perform reliably over time. According to an embodiment, adjustable fixture support magnet 100 may be constructed of aluminum, steel, thermoplastics, or a combination of suitable materials. Manufacturing costs, weight, lifespan and mechanical strength may be considerations informing the choice of materials, construction technique and design choices of adjustable fixture support magnet 100.

According to an embodiment, there is provided a system for magnetically mounting at least one fixture, comprising: at least one fixture support magnet 100 as described herein; at least one support bracket 300; and at least one magnetic plate 400. At least one fixture support magnet 100 may be affixed to the at least one fixture. At least one support bracket 300 may be installed within a wall along which the at least one fixture is to be suspended to provide an anchor for at least one magnetic plate 400. A size and shape of at least one support bracket 300 may vary. According to an embodiment, at least one support bracket 300 is constructed of aluminum rectangular tubing. The aluminum rectangular tubing may comprise ⅜″ thick aluminum rectangular tubing. At least one magnetic plate 400 may be installed within the wall and affixed to support bracket 300. According to an embodiment, at least one magnetic plate 400 is affixed to support bracket 300 with self-tapping screws. At least one magnetic plate 400 may thereafter provide the magnetic force requisite to the suspension on the wall of the at least one fixture to which at least one fixture support magnet 100 has been affixed. According to an embodiment, at least one magnetic plate 400 comprises at least one steel plate. A size and shape of at least one magnetic plate 400 may vary. At least one magnetic plate 400 may be ⅛″ thick.

According to an embodiment, the system for magnetically mounting at least one fixture further comprises facing paper. The facing paper may be applied to holes created in a section of drywall in the course of installing support bracket 300 to fill and repair the holes. According to a further embodiment, the facing paper comprises gypsum facing paper.

The system for magnetically mounting at least one fixture may further comprise an adhesive. The adhesive may be applied to the facing paper to adhere the facing paper to the section of drywall. According to an embodiment, the adhesive comprises double-sided industrial grade mounting tape.

According to a further embodiment, the system for magnetically mounting at least one fixture may further comprise plaster and dry wall mesh. The plaster and drywall mesh may be applied to the section of drywall and the facing paper to camouflage the facing paper and provide a more durable, water resistant and uniform finish to the section of drywall being filled/repaired.

The system for magnetically mounting at least one fixture may further comprise at least one fixture. According to an embodiment, the at least one fixture comprises at least one of a cabinet and a shelf.

According to an embodiment, there is provided a method of magnetically mounting at least one fixture, comprising: installing at least one magnetic plate behind at least one section of drywall; affixing at least one fixture support magnet to a rear face of the at least one fixture; positioning the rear face of the at least one fixture parallel to and proximate the at least one magnetic plate.

The at least one magnetic plate is positioned behind the at least one section of drywall on which the at least one fixture is to be mounted. A size and shape of the at least one magnetic plate determines a size and shape of an area along the at least one section of drywall within which the at least one fixture may be mounted and later repositioned. The at least one fixture support magnet provides a mechanism for mounting the at least one fixture. When the rear face of the at least one fixture is positioned parallel to and proximate the at least one magnetic plate, the at least one fixture support magnet on the at least one fixture is attracted to the at least one magnetic plate and thereby attaches the at least one fixture to the at least one section of drywall behind which the at least one magnetic plate is installed.

According to an embodiment, the step of affixing at least one fixture support magnet to a rear face of the at least one fixture comprises: inserting a base of the at least one fixture support magnet into a corresponding recess in the rear face of the at least one fixture; and drilling at least one screw into the rear face of the at least one fixture through a screw hole in the base of the fixture support magnet.

According to an embodiment, the method of magnetically mounting at least one fixture further comprises the step of adjusting a height of the at least one fixture support magnet by twisting the collar in one of a clockwise direction and a counterclockwise direction. Twisting the collar in a clockwise direction may lower the receptacle and magnet and reduce the height of the at least one fixture support magnet. Twisting the collar in a counterclockwise direction may raise the receptacle and magnet and increase the height of the at least one fixture support magnet. In this manner, a degree to which the at least one fixture support magnet protrudes from the rear face of the at least one fixture can be adjusted. The height of the at least one fixture support magnet may need to be adjusted where a wall to which the at least one fixture is being mounted is sloped or uneven, for example.

According to a further embodiment, the method of magnetically mounting at least one fixture further comprises installing at least one support bracket behind the at least one section of drywall. The step of installing at least one support bracket behind the at least one section of drywall may comprise affixing the at least one support bracket to at least one stud. The step of installing at least one magnetic plate behind at least one section of drywall may comprise affixing the at least one magnetic plate to the at least one support bracket. The at least one magnetic plate may be affixed to the at least one support bracket with self-tapping screws.

According to an embodiment, the method of magnetically mounting at least one fixture further comprises patching at least one hole in the at least one section of drywall. The step of patching at least one hole in the at least one section of drywall may comprise applying an adhesive to a first side of at least one piece of facing paper; applying the at least one piece of facing paper to the at least one section of drywall; and applying drywall mesh and plaster to each of the at least one piece of facing paper and the at least one section of drywall. According to an embodiment, the adhesive comprises double-sided industrial grade mounting tape. The at least one piece of facing paper may comprise at least one piece of gypsum facing paper.

Various embodiments of the invention have been described in detail. Since changes in and or additions to the above-described best mode may be made without departing from the nature, spirit or scope of the invention, the invention is not to be limited to those details but only by the appended claims. Section headings herein are provided as organizational cues. These headings shall not limit or characterize the invention set out in the appended claims.

What is claimed is:

1. An adjustable fixture support magnet, comprising:
a magnet;
a receptacle configured to receive the magnet;
a cover, comprising an external first screw thread;
a locking mechanism removably connecting the receptacle with the cover; and
a base, comprising an internal second screw thread corresponding to the first screw thread.

2. The device of claim 1, wherein each of the receptacle, the cover and the base is substantially circular.

3. The device of claim 1, wherein the locking mechanism comprises:
a recessed track in an outer surface of the receptacle; and
a projection an inner surface of the cover of a size corresponding to a width of the recessed track.

4. A system for magnetically mounting at least one fixture, comprising:
at least one fixture support magnet according to claim 1;
at least one support bracket; and
at least one magnetic plate.

5. The system of claim 4, further comprising facing paper.

6. The system of claim 5, wherein the facing paper comprises gypsum facing paper.

7. The system of claim 5, further comprising an adhesive.

8. The system of claim 7, wherein the adhesive comprises double-sided industrial grade mounting tape.

9. The system of claim 7, further comprising plaster.

10. The system of claim 4, further comprising:
at least one fixture.

11. The system of claim 10, wherein the at least one fixture comprises at least one of a cabinet and a shelf.

12. A method of magnetically mounting at least one fixture, comprising:
installing at least one magnetic plate behind at least one section of drywall;
affixing at least one fixture support magnet to a rear face of the at least one fixture;
positioning the rear face of the at least one fixture parallel to and proximate the at least one magnetic plate.

13. The method of claim 12, further comprising adjusting a height of the at least one fixture support magnet by twisting a cover of the at least one fixture support magnet in one of a clockwise direction and a counterclockwise direction.

14. The method of claim 12, further comprising:
installing at least one support bracket behind the at least one section of drywall.

15. The method of claim 14, wherein the step of installing at least one magnetic plate behind at least one section of drywall comprises affixing the at least one magnetic plate to the at least one support bracket.

16. The method of claim 14, wherein the step of installing at least one support bracket behind the at least one section of drywall comprises affixing the at least one support bracket to at least one stud.

17. The method of claim 12, wherein the step of affixing at least one fixture support magnet to a rear face of the at least one fixture comprises:
inserting a base of the at least one fixture support magnet into a corresponding recess in the rear face of the at least one fixture; and
drilling at least one screw into the rear face of the at least one fixture through a screw hole in the base of the fixture support magnet.

18. The method of claim 12, further comprising:
patching at least one hole in the at least one section of drywall.

19. The method of claim 18, wherein the step of patching at least one hole in the at least one section of drywall comprises:
applying an adhesive to a first side of at least one piece of facing paper;
applying the at least one piece of facing paper to the at least one section of drywall; and
applying drywall mesh and plaster to each of the at least one piece of facing paper and the at least one section of drywall.

20. The method of claim 19, wherein the adhesive comprises double-sided industrial grade mounting tape.

21. The method of claim 19, wherein the at least one piece of facing paper comprises at least one piece of gypsum facing paper.
